(19) United States
(12) Patent Application Publication
(10) Pub. No.: US 2006/0067623 A1
(43) Pub. Date: Mar. 30, 2006

(54) Reflector for a lighting and/or signalling device for an automobile

(76) Inventors: Gilles Viard, Bobigny Cedex (FR); Julien Carboneil, Bobigny Cedex (FR)

Correspondence Address: MORGAN & FINNEGAN, L.L.P., 3 WORLD FINANCIAL CENTER, NEW YORK, NY, 10281-2101, US

(21) Appl. No.: 11/232,147

(22) Filed: Sep. 20, 2005

(30) Foreign Application Priority Data
Sep. 21, 2004 (FR) 04 09 982

(51) Int. Cl. G02B 6/26

(52) U.S. Cl. 385/46

(57) ABSTRACT

The object of the invention is a reflector intended to equip a lighting or signalling device for an automobile and comprising a polymer-based structure at least partly covered with a reflective coating, the said structure also comprising fibres.

### FIELD OF THE INVENTION

The object of the present invention is reflectors intended to be incorporated in lighting or signalling devices for automobiles, of the headlight or light type.

### BACKGROUND OF THE INVENTION

A reflector is an important optical part in a headlight, if the example of a headlight is taken. This is because its role is to best reflect the light emitted by the light source or sources generally placed at the bottom of the cavity that it forms, so that the resulting light beam emitted by the headlight or light complies with the required photometric pattern. To do this, efforts are made to develop reflectors simultaneously meeting two criteria:

firstly, their reflective surface (the one that is optically active and receives the light from the light source) must also be as little absorbent as possible in the visible range. This is because the more light that is absorbed by the reflector, the more the efficiency of the lamp drops, since there is a loss of light flux,

secondly, this reflective surface is also advantageously able to reflect the light with an angular distribution of the reflected rays with respect to the incident rays that can be controlled, that is adjustable. This is because modulating the angular distribution of the reflected rays make it possible to adapt the reflector, according to the type of headlight, for example according to the type of light sources employed and according to whether the optical module containing the reflector will or will not be movable in the headlight.

In addition, there exist two major types of reflector:

metallic reflectors, which resist thermal and mechanical stresses well but which are often fairly heavy and which may, through their manufacturing method, only with difficulty make it possible to obtain complicated shapes or the integration of related components of the lamp fixing means type,

reflectors based on a polymer or polymers, thermosetting or thermoplastic, which on the other hand have the advantage of lightness and great flexibility in the shapes obtained, since they are fabricated by moulding techniques of the injection type. The latter type of reflector is, after moulding, made reflective generally by the deposition of a lacquer, and then a reflective metallic coating of the aluminium type. The role of the lacquer is to facilitate the adhesion of the metallic coating and to optimise the surface state of the reflector in order to improve its optical performance, in particular its reflection coefficient.

The invention concerns more particularly reflectors based on a polymer or polymers. Its aim is to develop polymer-based reflectors with improved optical properties. A secondary aim is to develop reflectors of this type having a simplified/facilitated method of obtaining.

### SUMMARY OF THE INVENTION

The object of the invention is first of all a reflector intended to equip a lighting or signalling device for an automobile and comprising a structure based on a polymer or polymers covered at least partly with a reflective coating, the said structure also comprising fibres.

Fibres means elements having an elongate shape, for example a length at least ten times and in particular at least 100 or 1000 times greater than what can be assimilated to its diameter when a fibre of approximately cylindrical shape is concerned. These fibres are advantageously of a different nature than that of the structure of the polymers in which they are situated.

The invention thus discovered that incorporating a fibrous material in the polymer structure of the reflector was feasible and extremely advantageous in more than one regard. The presence of these fibres make it possible in fact to modify the surface state of the polymer structure in a controlled fashion before being covered with the reflective coating: it makes it possible to select the level of surface roughness such that the metallic coating “following” this roughness will be able to reflect the rays emitted by the light source with a wide angular distribution. Entirely surprisingly, it turned out that this surface modification due to the presence of the fibres did not have an appreciable negative impact (within the limit of a concentration by weight of the fibres of less than approximately 50%) on the weak light absorption of the reflector once provided with its reflective coating.

Advantageously, the said structure is covered by the reflective coating either directly or by means of one or more layers with a low total thickness, generally less than 50 nm, in particular less than 10 nm, obtained by a vacuum deposition method (below 0.10 Mbar): in addition, the invention makes it possible to considerably limit the thickness of the intermediation deposition, or even to omit it completely, which significantly simplifies and shortens the process of manufacturing the reflector. This very fine undercoat may in particular serve as a barrier layer to corrosion. A lacquer deposition step is eliminated (reworking deposition, then drying/cross-linking of the lacquer). Up to then, lacquers were generally deposited in thicknesses of around one micrometer, not around one nanometre (for example between 20 and 50 microns), which considerably modified the roughness compared with the surface resulting from injection moulding. The addition of fibres is not an additional step, since the normal method of moulding polymer structures, of the injection type, is applied in an entirely similar fashion to a matrix of polymers alone or to a mixture of matrix+fibres.

In addition again, this fibrous material can also have a positive impact on the mechanical properties of the reflector, by also fulfilling the role of a reinforcement material. It is thus possible to design thinner reflectors, even more lightweight, with an identical mechanical performance level, or, when high mechanical stresses exist, to recommend polymer reflectors where usually entirely metal reflectors would be recommended.

The surface roughness level of the polymer structure is preferably adjusted (for example by modulating the characteristics of the fibres, in particular their proportion in the structure) so that its surface state has a roughness such that its mean arithmetic deviation Ra is at least 0.1 micrometers, in particular at least 0.2 micrometers. Preferably again, the surface state of the polymer-based structure has a roughness such that its arithmetic mean of the local surface slopes Sda is at least 10 mradians, in particular at least 15 mradians. The conjunction of these two types of roughness measurement, advantageously, makes it possible to achieve the maximum optical performance required for the reflector.

Advantageously, it happens that the surface state of the polymer-based structure has an influence on that of the surface coating that will at least partially cover it thereafter: the roughness levels mentioned above are generally similar and of the same order of magnitude as the roughness levels measured on the reflective surface once deposited on the polymer structure. Thus, preferably, the surface state of the reflector measured on the reflective coating of the reflector has a roughness such its mean arithmetic deviation Ra is at least 0.1 micrometers, in particular 0.2 micrometers and/or its arithmetic mean of the local surface slopes Sda is at least 10 mradians, in particular 15 mradians.

Advantageously, the fibres are essentially mineral in nature and are in particular glass. Use can also be made of fibres made from a ceramic material, or carbon fibres.

Fibres of the reinforcement fibre type are favoured, used also for the mechanical reinforcement of polymers in other fields in industry. This type of fibre generally consists of multitudes of unitary fibres, the cohesion of which before introduction into the polymer is provided by appropriate oiling. The oiling is also designed to be chemically compatible with the polymer to be reinforced and to promote the adhesion and dispersion of the fibres in the matrix,

These reinforcement fibres can be used in various forms: they can be introduced into the polymer matrix in the form of rovings or strands. These rovings or strands are preferably cut before introduction into the polymer or polymers and themselves based on unitary filaments. “Polymer” or “polymers” means:

polymers already polymerised before moulding, which is generally the case with polymers of the thermoplastic type,

but also polymers not (entirely) polymerised or the precursers/prepolymers/crosslinking agents constituting the matrix which, once processed and moulded, will constitute the completed polymer structure mentioned above; this is the case with polymers of the thermosetting type or certain thermoplastics.

The choice of the roving or strand, the choice of the length of cut or the length or diameter of the unitary filaments or the proportion of fibres with respect to the polymer are the parameters that can be adjusted according to the results sought.

For example, the strands or rovings can be cut to a length of between 3 and 12 mm, in particular between 4 and 10 mm, more particularly around 6 mm. It should be noted that it is a question here of the initial length of the fibres when they are introduced into the polymer matrix but that it can change (decrease) during the process up to the end of the moulding operation.

Preferably again, the strands or rovings are based on unitary filaments with a diameter of between 8 and 30 micrometers, in particular between 15 and 30 micrometers. Advantageously, the polymer-based structure has a proportion of fibres of at least 5% by weight, in particular at least 15%, preferably between 20% and 40% by weight. It was in fact observed, all other things being equal, that there were preferred ranges of proportions, below which the improvement of the optical properties of the reflector was not significant, and beyond which the effect began to stagnate or even to decrease. The light absorption of the surface then became preponderant. On the other hand, up to a certain maximum threshold, it was possible, by modulating the proportion of fibres, to modulate the angular distribution of the rays reflected by the reflector. Thus, in the case where the reflector is associated with a light source of the standard halogen lamp type, there is an advantage in favouring a small angular distribution, that is to say a cone of distribution of the angles reflected by a relatively narrow given reflective surface unit, since the total flux emitted by this type of lamp is less high than that emitted by an equivalent lamp of the xenon type. On the other hand, with a xenon lamp, which emits a greater light flux, it may be advantageous to chose a wide angular distribution, that is to say a wide scattering of the reflected rays, in order to aim at a very homogeneous reflected beam, since it can then be accepted possibly losing a small amount of efficiency concerning the light flux. It is also possible to cite the case of headlights with a dynamic bending light function, where it is generally sought for the reflected light beam to be particularly homogeneous, and therefore to have a wide angular distribution, which is not necessarily the case with headlights without a movable optical module.

It is also possible to provide for the polymer-based structure also to comprise fillers, in particular lamella fillers of the talc or mica type, or granular fillers of the carbonate type. Their presence may make it possible to reduce the raw materials cost of the structure, or facilitate moulding operations. Finally, it can also have a favourable influence on the mechanical properties of the structure. However, unlike fibres with an elongate shape, they do not appreciably modify the surface roughness.

The structure of the reflector is advantageously based on a thermosetting or thermoplastic polymer or polymers, in particular chosen from amongst polysulphones, polyethersulphones, polyester, polyetherimides and phenylene polysulphides.

Advantageously, the presence of fibres within the polymer of the reflector increases the mechanical properties of the reflector, which makes possible/facilitates the integration in the said reflector of accessory components, in particular mechanical fixing components, of the lamp holder type, or obturator elements of the moving or fixed screen or shield type.

Another object of the invention is a method of manufacturing a reflector intended to equip a lighting or signalling device for an automobile and comprising a polymer-based structure at least partly covered with a reflective coating, such that the said structure is fabricated by moulding, of the injection type, of a mixture containing one or more polymers, fibres of the glass fibre type and possibly fillers.

Another object of the invention is any lighting or signalling device for an automobile, comprising at least one reflector as described previously.

Another object of the invention is any vehicle provided with such a device.

The invention will be detailed below with non-limiting examples, with the help of the following figures:

### BRIEF DESCRIPTION OF THE DRAWINGS

FIG. 1a: a schematic representation of a section of an optical module with a reflector according to a comparative example

FIG. 1b: the same representation as in FIG. 1 according to the example of the invention

FIGS. 2a-2b: schematic representation of surface states

FIG. 3a: a representation of the isolux curves of a beam emitted by the optical module according to the comparative example

FIG. 3b: a representation of the isolux curves of a beam emitted by the optical module according to the example of the invention.

### DESCRIPTION OF THE PREFERRED EMBODIMENTS

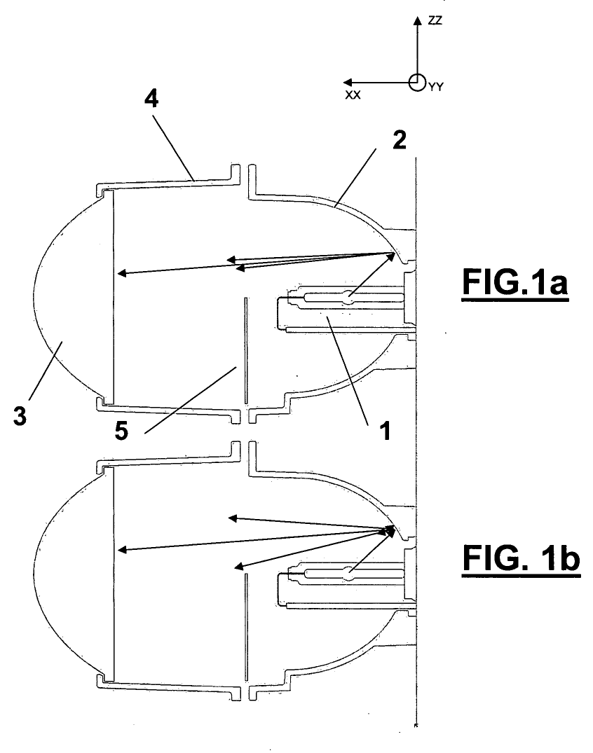

The invention is applied in examples described below, non-limitingly, to reflectors based on thermoplastic polymers used in optical modules of the elliptical type. The structure of the elliptical modules is given briefly with the help of FIGS. 1a and 1b: these modules, intended to be integrated in automobile headlights, comprise a light source 1, for example a xenon lamp or halogen lamp. Xenon lamps offer the advantage of emitting a more intense light flux than halogen lamps and having, under the normal conditions of use, a longer service life and a lower electrical consumption. The modules also comprise a reflector 2, a lens 3, carried by an intermediate piece 4. When it is a case of a so-called “dual function” module, that is to say one that is able to emit two beams of different types, in particular a long-range beam of the main beam type or a so-called “cut-off” beam of the dipped or fog type, a movable shield 5 is provided: in the high position, it makes it possible to obtain, in a known fashion, the required cut-off beam. When it is retracted, for example by a tilting movement about a horizontal axis YY parallel to the optical axis XX as depicted by the arrow in FIG. 1a, it no longer forms an obstruction to the light and a beam of the main beam type is then obtained. If there is no flap, or if, on the other hand, there is a flap that is fixed, there is then a so-called “single-function” module. If the flap is movable and can have more than two different positions, it is also possible to have a “multifunction” module, able to emit more than two different beams.

In the example depicted, there is a dual function dipped/main beam module. It will be understood that, when the movable flap is in the dipped position, part of the light beam emitted by the lamp is “lost”, the part that strikes the flap.

It is therefore important for the reflector, in particular in this configuration, not to waste more flux, and therefore for it to be as little absorbent in the visible range as possible. Moreover, it is very advantageous, more particularly in the case where a xenon lamp is used, for it to be capable of reflecting the incident light in a wide angular range, at least in a not purely specular fashion. Before going into details on the embodiment of the invention, reference can be made to FIG. 1a to see a representation of a light reflection by the reflector that is not satisfactory: this is a representation according to a comparative example No 1, where the reflector is not produced according to the invention. It can be seen that, compared with a given incident ray coming from the lamp, the rays are reflected by the reflector 2 with a much lesser (almost zero) angular amplitude than in example No 2 according to the invention depicted in FIG. 1b. The invention therefore makes it possible to obtain a low-absorbance reflector able to reflect in a diffusing fashion, the latter characteristic guaranteeing homogeneity of the beam emitted by the significantly improved headlight. In concrete terms this means, as detailed below, that there will be no, or fewer, spots more intense than others in the beam, and that there will be sharper, better, isolux contours.

### COMPARATIVE EXAMPLE NO 1

A reflector 2 manufactured in the following fashion is used: a polymer, polyphenylsulphide (PPS) with mineral fillers is injection-moulded in a ratio by weight of 40% polymer/60% fillers. These fillers consist of talc, mica and carbonates.

The moulding method is known per se. Optionally a very fine layer based on polysiloxane (hexamethyldisiloxane) is deposited over 2 to 5 nm. The function of this layer is in particular that of a chemical barrier, without causing any appreciable modification to the surface state of the underlying polymer. Next, on the internal face, the optically active face of the reflector, an aluminium coating is deposited to a thickness of approximately 50 to 100 nm by a known vacuum metallisation process of the evaporation or sputtering type.

### EXAMPLE ACCORDING TO THE INVENTION NO 2

The comparative example is reproduced but adding a second component to the polymer+filler matrix before injection: reinforcement glass fibres are added in the form of threads consisting of unitary filaments approximately 15 micrometers in diameter and cut to a length of approximately 6 mm. The oiling of the fibres is compatible with PPS. The ratio by weight of polymer/fillers/glass fibres is 40/30/30.

The surface state of the two reflectors was then studied before and after aluminising, and the homogeneity of the optical beam obtained with each of the two modules was estimated.

It was then observed that the higher quality of the optical beam obtained with reflector No 2 was related to a level of roughness, to a surface state of the polymer matrix before aluminising, very different from that observed with the reflector according to example No 1.

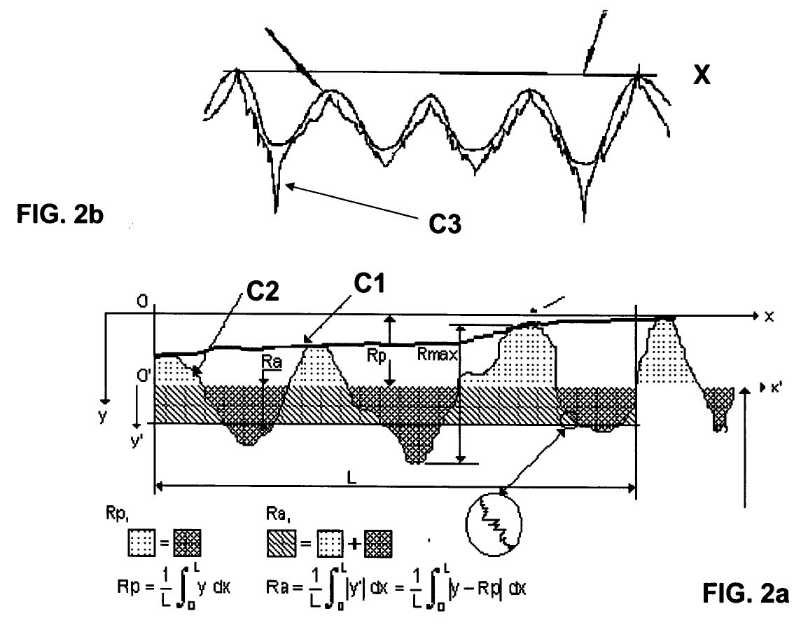

FIGS. 2a to 2b show to what the surface roughness parameters that were measured corresponded:

in FIG. 2a, a given surface state can be seen, from which it is possible to calculate the so-called “arithmetic mean deviation” parameter for Ra which is the arithmetic mean of the absolute values of the ordinate y′ between each point on the curve of the axis ox′, with the axis ox′ the mean line, the axis ox the geometric profile, the curve C1 the upper envelope line and the curve C2 the effective profile of the surface. FIG. 2a also shows the entire calculation for arriving at the value of Ra of the surface.

FIG. 2b shows a surface state with the arrows representing the so-called “arithmetic mean of the local surface slopes” parameter or Sda, the X axis representing the overall direction of the profile, and the curve C3 the effective profile having undulations.

The calculation of these parameters is defined with more precision in the standards ISO 11562, ISO 3274, ISO 4287 and ISO 12085.

The table below gives the value of Ra and Sda of the reflectors according to examples 1 and 2, measured on the reflectors at the surface intended to be aluminised. It should be noted that these values were then measured on the surface of the reflectors once aluminised, the values were very close, or even identical, to the values before aluminising.

| | Ra (μm) | Sda (mrad) |
|---|---|---|
| Example 1 (comparative) | 0.06 | 8.8 |
| Example 2 (invention) | 0.28 | 24.7 |

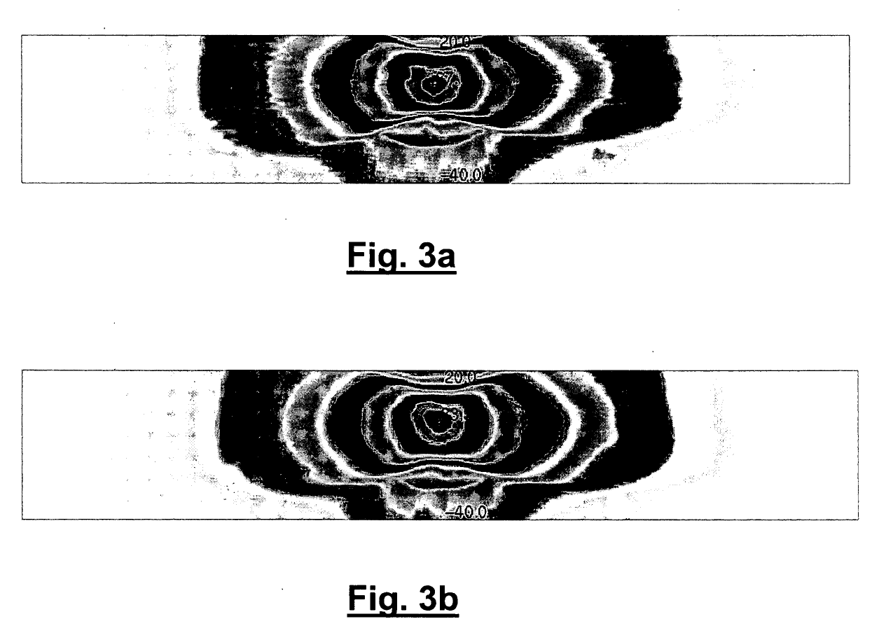

FIGS. 3a (example 1) and 3b (example 2) also show the isoluxes obtained with each of the optical modules using a lamp 1 of the halogen type H7 at a distance of approximately 15 m. An optician can very quickly see, in the light of these isoluxes, that the module according to example 1 is less good in terms of homogeneity of the beam than the module according to example 2, in all respects identical to the previous one apart from the presence of reinforcing fibres in the reflector: the isoluxes, in particular those most close to the maximum intensity point, have a less sharp contour with the comparative example without glass fibre.

The inventors have thus discovered that adding a fibrous material to the polymer of the deflector substantially modifies its surface state: the values of Ra and Sda are multiplied by at least a factor of 3.

This adjustment of the surface state, this substantial increase in the surface roughness, by the addition of glass fibres, has a very advantageous and surprising impact: there are excellent optical results, the reflector, once aluminised, is very little absorbent and has a high spectacular reflection. On an industrial level, there is no longer any need to deposit an intermediate coating of the lacquer type between the polymer and the reflective coating in order to obtain a given type of diffusion. Moreover the reflector modified according to the invention passes the durability test normally performed in the automobile field without any problem, like a standard solid aluminium reflector or the reflector according to example 1. Finally, the presence of the fibres also has a very favourable impact on the mechanical properties of the reflector: measurements have been made of elastic moduli and bending moduli according to ISO 527 on test pieces on polymer+filler mixtures according to example 1 and polymer+filler+glass fibre mixtures according to example 2. The values are set out in the table below.

| | Test piece according | Test piece according |
|---|---|---|
| | to example 1 | to example 2 |
| Elastic modulus | 8763 | 14938 |
| | (for 1.1% elongation) | (for 1.25% elongation) |
| Bending modulus | 8104 | 14203 |

(Unit Mpa)

It can be seen that there is at least a factor of 1.7 between the two examples for each of the values measured: the reflectors according to the invention are appreciably more robust mechanically than the standard polymer reflectors, with or without intermediate lacquer. This means that it is then possible, with the invention, to reduce the thickness of the reflectors and/or to mould the reflector and the related components of the mechanical fixing means in a single piece.

The invention has therefore allowed an improvement in the mechanical and optical properties of the reflector, with a simpler manufacturing method, since it is possible without any drawback to eliminate the intermediate layer of lacquer, or at least to significantly reduce the thickness thereof. It should also be noted that the invention can in the same way be applied to reflectors based on thermosetting rather than only thermoplastic polymers. It also applies to any lighting or signalling module, and is therefore not limited to an application to elliptical modules.

It also applies to reflectors that can be used for the internal lighting of automobiles.

What is claimed is:

1. Reflector intended to equip a lighting or signalling device for an automobile and comprising a polymer-based structure covered at least partly with a reflective coating, characterised in that the said structure also comprises fibres.

2. Reflector according to claim 1, wherein the structure is covered with the reflective coating directly or by means of one or more layers with a total thickness of no more than 50 nm, in particular no more than 10 nm.

3. Reflector according to claim 1, wherein the surface state of the polymer-based structure has a roughness such that its mean arithmetic deviation Ra is at least 0.1 micrometers, in particular at least 0.2 micrometers.

4. Reflector according to claim 1, wherein the surface state of the polymer-based structure has a roughness such that its arithmetic mean of the local surface slopes Sda is at least 10 mradians, in particular at least 15 mradians.

5. Reflector according to claim 1, wherein the surface state of the reflector measured on the reflective coating of the reflector has a roughness such that its mean arithmetic deviation Ra is at least 0.1 micrometers, in particular at least 0.2 micrometers, and/or its arithmetic mean of the local surface slopes Sda is at least 10 mradians, in particular at least 15 mradians.

6. Reflector according to claim 1, wherein the fibres are of a mineral nature, in particular in the form of glass fibres.

7. Reflector according to claim 1, wherein the fibres are reinforcing fibres, in particular introduced into the polymer matrix in the form of rovings or strands, in particular cut, and themselves based on unitary filaments.

8. Reflector according to claim 7, wherein the strands or rovings are cut to a length of between 3 and 12 mm or in particular between 4 and 10 mm.

9. Reflector according to claim 7, wherein the strands or rovings are based on unitary filaments with a diameter between 8 and 30 micrometers, in particular between 15 and 30 micrometers.

10. Reflector according to claim 1, wherein the polymer-based structure also comprises fillers, in particular lamellar fillers of the talc or mica type or granular fillers of the carbonate type.

11. Reflector according to claim 1, wherein the polymer-based structure has a proportion of fibres of at least 5% by weight, in particular at least 15%, preferably between 20% and 40% by weight.

12. Reflector according to claim 1, wherein the structure is based on a thermoplastic polymer or polymers, in particular polysulphones, polyethersulphones, polyester, polyetherimides or phenylene polysulphides.

13. Reflector according to claim 1, wherein mechanical fixing elements are integrated in the said reflector, in particular a lamp holder or ocuulting elements, or a movable or fixed shield.

14. Method of manufacturing a reflector intended to equip a lighting or signalling device for an automobile and comprising a polymer-based structure at least partly covered with a reflective coating, wherein the said structure is manufactured by the moulding, of the injection type, of a mixture containing one or more polymers, fibres of the glass fibre type and possibly fillers.

15. Lighting or signalling device for an automobile, comprising at least one reflector according to claim 1.
